(19) United States
(12) Patent Application Publication
(10) Pub. No.: US 2022/0156344 A1
(43) Pub. Date: May 19, 2022

(54) SYSTOLIC ARRAY CELLS WITH OUTPUT POST-PROCESSING

(71) Applicant: Google LLC, Mountain View, CA (US)

(72) Inventor: Jeremiah Willcock, Santa Clara, CA (US)

(21) Appl. No.: 17/530,106

(22) Filed: Nov. 18, 2021

Related U.S. Application Data
(60) Provisional application No. 63/116,034, filed on Nov. 19, 2020.

(51) Int. Cl. G06F 17/16; G06F 15/80; G06F 5/01

(52) U.S. Cl. CPC G06F 17/16; G06F 5/01; G06F 15/8046

(57) ABSTRACT

This specification relates to systolic arrays of hardware processing units. In one aspect, a matrix multiplication unit includes multiple cells arranged in a systolic array. Each cell includes multiplication circuitry configured to determine a product of elements of input matrices. Each cell includes an accumulator configured to determine an accumulated value by accumulating a sum of the products output by the multiplication circuitry. Each cell also includes a post-processing component configured to determine a post-processed value by performing one or more post-processing operations on the accumulated value.

### CROSS-REFERENCE TO RELATED APPLICATIONS

This application claims the benefit under 35 U.S.C. § 119(e) of U.S. Patent Application No. 63/116,034, titled “SYSTOLIC ARRAY CELLS WITH OUTPUT POST-PROCESSING,” filed on Nov. 19, 2020. The disclosure of the foregoing application is incorporated herein by reference in its entirety for all purposes.

### TECHNICAL FIELD

This specification relates to systolic arrays of hardware processing units.

### BACKGROUND

A systolic array is a network of processing units that compute and pass data through the network. The data in the systolic array flows between the processing units in a pipelined manner and each processing unit can independently compute a partial result based on data received from its upstream neighboring processing units. The processing units, which can also be referred to as cells, can be hard-wired together to pass data from upstream processing units to downstream processing units. Systolic arrays are used in machine learning applications, e.g., to perform matrix multiplications.

### SUMMARY

In general, one innovative aspect of the subject matter described in this specification can be embodied in a matrix multiplication unit that includes multiple cells arranged in a systolic array. Each cell includes multiplication circuitry configured to determine a product of elements of input matrices. Each cell includes an accumulator configured to determine an accumulated value by accumulating a sum of the products output by the multiplication circuitry. Each cell also includes a post-processing component configured to determine a post-processed value by performing one or more post-processing operations on the accumulated value.

These and other implementations can each optionally include one or more of the following features. In some aspects, each cell further includes an output register configured to receive the post-processed value and shift the post-processed value out of the cell.

In some aspects, the post-processing component includes rounding circuitry configured to round the accumulated value from a higher precision number format to a lower precision number format. Each cell can include a number of output wires equal to a number of bits of the lower precision number format. This rounding within the cells can reduce the output bandwidth. Reducing the output bandwidth can, in turn, reduce the number of wires required to extract the output data from the cells. The reduction in the number of wires can enable smaller die sizes for the systolic arrays or higher quantities of cells per die without increasing the die size.

In some aspects, the post-processing component comprises truncating circuitry configured to truncate the accumulated value from a higher precision number format to a lower precision number format. In some aspects, the post-processing component includes rectified linear unit (ReLU) circuitry configured to output the accumulated value when the accumulated value is positive and output a value of zero when the accumulated value is negative or zero. In some aspects, the post-processing component is programmable and is configured to perform one of multiple post-processing operations based on a control signal.

In general, another innovative aspect of the subject matter described in this specification can be embodied in a data processing cell. The data processing cell can include multiplication circuitry configured to determine a product of elements of input matrices, an accumulator configured to determine an accumulated value by accumulating a sum of the products output by the multiplication circuitry, and a post-processing component configured to determine a post-processed value by performing one or more post-processing operations on the accumulated value.

These and other implementations can each optionally include one or more of the following features. In some aspects, the cell can include an output register configured to receive the post-processed value and shift the post-processed value out of the data processing cell.

In some aspects, the post-processing component includes rounding circuitry configured to round the accumulated value from a higher precision number format to a lower precision number format. The cell can include a number of output wires equal to a number of bits of the lower precision number format. This rounding within the cells can reduce the output bandwidth. Reducing the output bandwidth can, in turn, reduce the number of wires required to extract the output data from the cells. The reduction in the number of wires can enable smaller die sizes for the systolic arrays or higher quantities of cells per die without increasing the die size.

In some aspects, the post-processing component includes truncating circuitry configured to truncate the accumulated value from a higher precision number format to a lower precision number format. The post-processing component can include ReLU circuitry configured to output the accumulated value when the accumulated value is positive and output a value of zero when the accumulated value is negative or zero. In some aspects, the post-processing component is programmable and is configured to perform one of multiple post-processing operations based on a control signal.

In general, another innovative aspect of the subject matter described in this specification can be embodied in a method for multiplying matrices. The method can include receiving, by a first input register of a cell, a first input matrix; receiving, by a second input register of the cell, a second input matrix; generating, by multiplication circuitry of the cell, products of elements of the first input matrix with elements of the second input matrix; generating, by an accumulator of the cell, an accumulated value accumulating the products; and performing, by a post-processing component of the cell, one or more post-processing operations on the accumulated value.

These and other implementations can each optionally include one or more of the following features. In some aspects, performing the one or more post-processing operations can include rounding the accumulated value from a higher precision number format to a lower precision number format.

In some aspects, performing the one or more post-processing operations can include truncating the accumulated value from a higher precision number format to a lower precision number format. Performing the one or more post-processing operations can include outputting the accumulated value when the accumulated value is positive and outputting a value of zero when the accumulated value is negative or zero.

In some aspects, performing the one or more post-processing operations can include receiving a control signal and performing a given post-processing operation of multiple post-processing operations based on the control signal.

Some aspects can include receiving, by an output register, the post-processed accumulated value from the post-processing component and shifting, by the output register, the post-processed accumulated value out of the cell.

The subject matter described in this specification can be implemented in particular embodiments so as to realize one or more of the following advantages. The systolic array cells described in this document can include a post-processing component that performs post-processing of the output of the cell prior to shifting the output from the cell. This post-processing within the cells can reduce the output bandwidth, which can reduce the number of wires required to extract the output data from the cells. For example, the post-processing can include reducing the precision of floating point numbers, e.g., from 32 bits to 16 bits, which can, in turn, reduce the number of output wires from 32 to 16 if the cells include one output wire per output bit. The reduction in the number of wires can enable smaller die sizes for the systolic arrays or higher quantities of cells per die without increasing the die size. The post-processing component can be a programmable element, which allows for greater flexibility in the types of post-processing operations that can be performed by each cell.

Various features and advantages of the foregoing subject matter are described below with respect to the figures. Additional features and advantages are apparent from the subject matter described herein and the claims.

### BRIEF DESCRIPTION OF THE DRAWINGS

FIG. 1 shows an example processing system that includes a matrix computation unit.

FIG. 2 shows an example architecture including a matrix computation unit.

FIG. 3 shows an example architecture of a cell inside a systolic array.

FIG. 4 shows an example architecture of a cell inside a systolic array.

FIG. 5 is a flow diagram of an example process for performing matrix multiplication and performing one or more post-processing operations.

Like reference numbers and designations in the various drawings indicate like elements.

### DETAILED DESCRIPTION

In general, this document describes systolic arrays of cells that include post-processing components. The cells can include computation units, e.g., multiplication and/or addition circuitry, for performing computations. For example, a systolic array can perform matrix-matrix multiplication on input matrices and each cell can determine a partial matrix product of a portion of each input matrix. A systolic array of cells can be part of a matrix computation unit of a processing system, e.g., a special-purpose machine learning processor used to train machine learning models and/or perform machine learning computations, a graphics processing unit (GPU), or another appropriate processing system that performs matrix multiplications.

The systolic array can perform an output stationary matrix multiplication technique in which each cell computes a partial sum of products of a portion of elements of the input matrices. In an output stationary technique, elements of the input matrices can be shifted in opposite, or orthogonal, directions across rows, or across columns, of the systolic array. Each time a cell receives a pair of matrix elements, the cell determines a product of the two elements and accumulates a partial sum of all of the products determined by the cell for its portion of the two input matrices. The elements of the input matrices can be individual elements or submatrices.

The post-processing component of a cell can perform post-processing operations on the partial results computed by the computation unit(s) of the cell. For example, if the computation unit(s) accumulate 32-bit floating point numbers, the post-processing component can round or truncate the floating point numbers to a lower precision floating point format, such as a 16-bit floating point format. The post-processing can be performed outside of the systolic array rather than by each cell. However, by performing post-processing within each cell, the output bandwidth of each cell can be reduced and the number of input and/or output wires of each cell can be reduced. For example, each cell can include 32 input wires to receive a 32-bit floating point number and 32 output wires to output a 32-bit floating point number. By rounding or truncating the floating point numbers within each cell, the number of input wires and/or output wires of each cell can be reduced by 50%, which can reduce the size of the multiplication unit and/or enable more cells per multiplication unit without increasing the size of the multiplication unit.

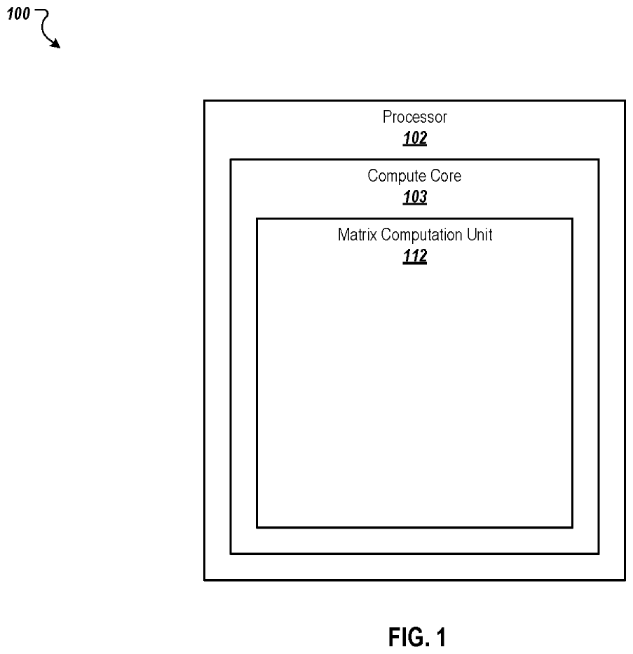

FIG. 1 shows an example processing system 100 that includes a matrix computation unit 112. The system 100 is an example of a system in which a matrix computation unit 112 that has a systolic array of cells that have post-processing components can be implemented.

The system 100 includes a processor 102, which can include one or more compute cores 103. Each compute core 103 can include a matrix computation unit 112 that can be used to perform matrix-matrix multiplication using a systolic array of cells that have post-processing components. The system 100 can be in the form of a special-purpose hardware chip.

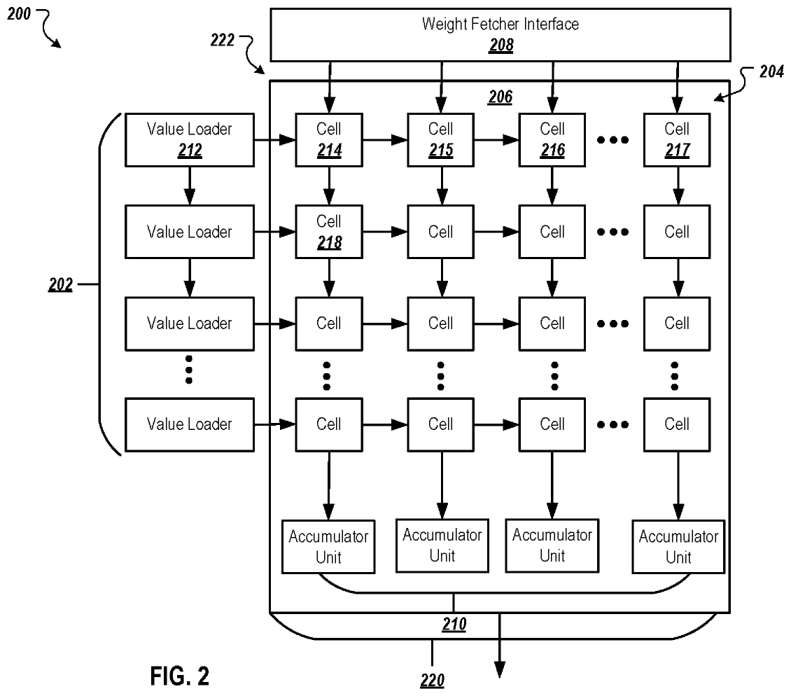

FIG. 2 shows an example architecture including a matrix computation unit 112. The matrix computation unit is a two-dimensional systolic array 206. The two-dimensional systolic array 206 can be a square array. The array 206 includes multiple cells 204. In some implementations, a first dimension 220 of the systolic array 206 corresponds to columns of cells and a second dimension 222 of the systolic array 206 corresponds to rows of cells. The systolic array 206 can have more rows than columns, more columns than rows, or an equal number of columns and rows. Thus, the systolic array 206 can have shapes other than a square.

In this example, the systolic array 206 is used for neural network computations. For example, the matrix computation unit 112 of FIG. 1 can be implemented as the systolic array 206. In other examples, the systolic array 206 can be used for matrix multiplication or other computations, e.g., convolution, correlation, or data sorting, in other applications.

In the illustrated example, value loaders 202 send activation inputs to rows of the array 206 and a weight fetcher interface 208 sends weight inputs to columns of the array 206. In some other implementations, however, activation inputs and weight inputs are transferred to opposite sides of the columns of the systolic array 206. If other types of inputs are used rather than activation inputs and weight inputs, the weight fetcher interface 208 can be replaced with another value such that value loaders can send inputs in opposite or orthogonal directions across the systolic array 206.

In another example, the value loaders 202 can send activation inputs across the rows of the systolic array 206 while the weight fetcher interface 208 sends weight inputs across the columns of the systolic array 206, or vice versa. In a neural network example, the value loaders 202 can send activation inputs to rows (or columns) of the array 206 and the weight fetcher interface 208 can send weight inputs to rows (or columns) of the array 206 from an opposite side (or orthogonal side) from that of the value loaders 202. In yet another example, the value loaders 202 can send the activation inputs diagonally across the array 206 and the weight fetcher interface 208 can send weight inputs diagonally across the array, e.g., in an opposite direction than that of the value loaders 202 or in a direction orthogonally to the direction of the value loaders 202.

The value loaders 202 can receive the activation inputs from a unified buffer or other appropriate source. Each value loader 202 can send a corresponding activation input to a distinct left-most cell of the array 206. The left-most cell can be a cell along a left-most column of the array 206. For example, value loader 212 can send an activation input to cell 214. The value loader can also send the activation input to an adjacent value loader, and the activation input can be used at another left-most cell of the array 206. This allows activation inputs to be shifted for use in another particular cell of the array 206.

The weight fetcher interface 208 can receive the weight input from a memory unit. The weight fetcher interface 208 can send a corresponding weight input to a distinct top-most cell of the array 206. The top-most cell can be a cell along a top-most row of the array 206. For example, the weight fetcher interface 208 can send weight inputs to cells 214-217.

In some implementations, a host interface shifts activation inputs throughout the array 206 along one dimension, e.g., to the right, while shifting weight inputs throughout the array 206 along an orthogonal dimension, e.g., down. For example, over one clock cycle, the activation input at cell 214 can shift to an activation register in cell 215, which is to the right of cell 214. Similarly, the weight input at cell 214 can shift to a weight register at cell 218, which is below cell 214. In other examples, the weight inputs can be shifted in an opposite direction (e.g., from right to left) than that of the activation inputs.

To determine a product of two matrices, e.g., one representing activation inputs and one representing weights, using an output-stationary technique, each cell accumulates a sum of products of matrix elements shifted into the cell. On each clock cycle, each cell can process a given weight input and a given activation input to determine a product of the two inputs. The cell can add each product to an accumulated value maintained by an accumulator of the cell. For example, the cell 215 can determine a first product of two matrix elements, e.g., a first activation input and a first weight input, and store the product in the accumulator. The cell 215 can shift the activation input to the cell 216 and shift the weight input to cell 214. Similarly, the cell 215 can receive a second activation input from cell 214 and a second weight input from cell 216. The cell 215 can determine the product of the second activation input and the second weight input. The cell 215 can add this to the previous accumulated value to generate an updated accumulated value.

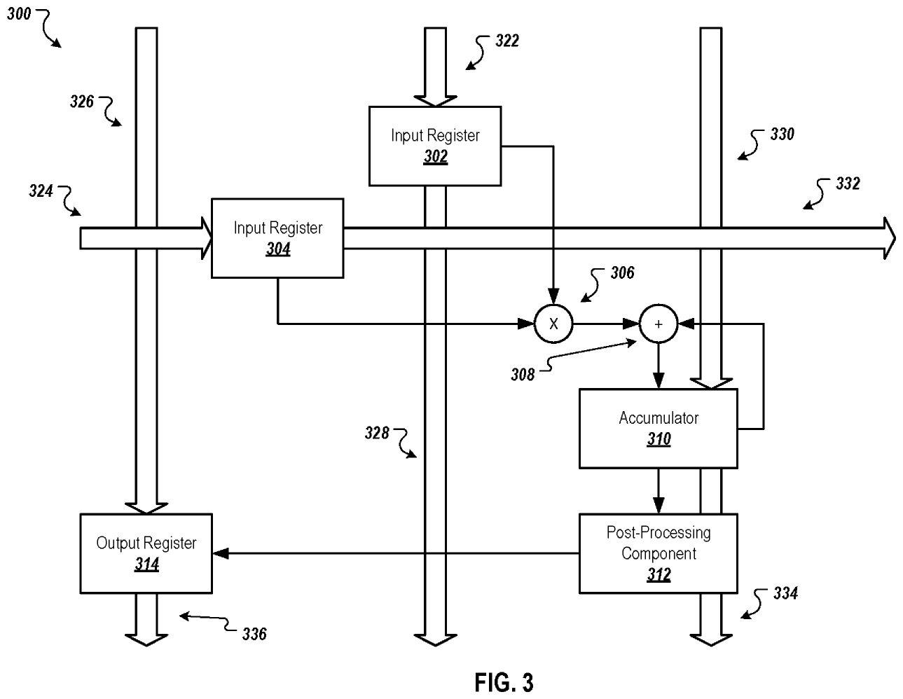

After all of the matrix elements have been passed through the rows and columns of the systolic array, each cell can shift out its accumulated value as a partial result of the matrix multiplication. Prior to shifting out the accumulated value, each cell can post-process the accumulated value and pass the post-processed output to an appropriate accumulator unit 210, e.g., the accumulator unit 210 in the same column as the cell. For example, each cell can round or truncate output numbers to lower precision numbers and pass the lower precision numbers to the accumulator unit 210. Example individual cells are described further below with reference to FIGS. 3 & 4.

The cells can pass, e.g., shift, the post-processed output along their columns, e.g., towards the bottom of the column in the array 206. In some implementations, at the bottom of each column, the array 206 can include accumulator units 210 that store and accumulate each post-processed output from each column. The accumulator units 210 can accumulate each post-processed output of its column to generate a final accumulated value. The final accumulated value can be transferred to a vector computation unit or another appropriate component.

The cells 204 of the systolic array 206 can be hardwired to adjacent cells. For example, the cell 215 can be hardwired to the cell 214 and to the cell 216 using a set of wires. In some implementations, when shifting output data out from a cell to an accumulator unit 210, the cell can output a numerical value in a single clock cycle. To do so, the cell can have an output wire for each bit of a computer number format used to represent the output value. For example, if the output value is represented using a 32-bit floating point format, e.g., float32 or FP32, the cell can have 32 output wires to shift out the entire output value in a single clock cycle.

In some cases, the input to computation units and/or to an accumulator of a cell has a lower precision than the internal precision of the computation unit and/or accumulator. For example, the floating point values of an input matrix can be 16-bit, e.g., in bfloat16 or BF16 format. However, the multiplication circuitry, summation circuitry, and/or accumulator can operate on higher precision numbers, e.g., FP32 numbers. In this example, the output of the accumulator of an upstream cell can be an FP32 number. Thus, to output the FP32 number in one clock cycle, the upstream cell can have 32 output wires to the downstream cell. By using a post-processor in each cell, as shown in FIG. 3, the number of output wires can be reduced, e.g., to 16 if the post-processor rounds or truncates the FP32 number to a BF16 number. FP32 and BF16 are used only as examples. The cells 204 can work with other number formats having other levels of precision.

By reducing the number of output wires in this way, the overall size of the systolic array can be reduced. That is, the die of an integrated circuit in which the systolic array is implemented can be reduced and/or the number of cells of the systolic array can be increased without increasing the size of the die.

FIG. 3 shows an example architecture 300 of a cell inside a systolic array. For example, the cells 204 of the systolic array 206 of FIG. 2 can be implemented using the architecture 300. The cells can be used to perform matrix-matrix multiplication of two input matrices. Although the cells will be described in terms of performing the matrix-matrix multiplication, the cells can be used to perform other computations, e.g., convolution, correlation, or data sorting.

The cell can include input registers, including input register 302 and input register 304. The input register 302 can receive an input matrix via a bus 322. For example, the input register 302 can receive elements of an input matrix from a right adjacent cell (e.g., an adjacent cell located to the right of the given cell) or from another component (e.g., a weight fetcher interface if used in the systolic array 206 of FIG. 2) depending on the position of the cell within the systolic array. Thus, each element of an input matrix received by the input register 302 can be a weight input.

The input register 304 can also receive elements of an input matrix via a bus 324. For example, the input register 304 can receive an input matrix from a left adjacent cell (e.g., an adjacent cell located to the left of the given cell) or from another component (e.g., a value loader or unified buffer if used in the systolic array 206 of FIG. 2) depending on the position of the cell within the systolic array. Thus, each element of an input matrix received by the input register 304 can be an activation input.

The cell includes multiplication circuitry 306 and summation circuitry 308. The multiplication circuitry 306 can determine the product of the matrix elements stored in the input registers 302 and 304. For example, the multiplication circuitry 306 can determine a product by multiplying the element of the input matrix stored in the input register 302 by the element of the input matrix stored in the input register 304. If the element of the input matrix received by the input register 302 is a weight input and the element of the input matrix received by the input register 304 is an activation input, the multiplication circuitry 306 can multiply the weight input with the activation input. The multiplication circuitry 306 can output the product to the summation circuitry 308.

The summation circuitry 308 can determine the sum of the product and an accumulated value stored in the accumulator 310 to determine a new accumulated value. The summation circuitry 308 can then send the new accumulated value to an accumulator 310. The accumulator 310 can store the current accumulated value.

After the multiplication is complete for all elements of the input matrices, the accumulator 310 can output the accumulated data to a post-processing component 312 of the cell. The post-processing component 312, which can be implemented using circuitry, can perform post-processing operations on accumulated data received from the accumulator 310.

In some implementations, the post-processing component 312 includes rounding circuitry configured to round an accumulated value from a higher precision number format to a lower precision number format. For example, the post-processing component 312 can round FP32 numbers to BF16 numbers.

The post-processing component 312 can include truncating circuitry for truncating accumulated value from a higher precision number format to a lower precision number format. For example, the post-processing component 312 can truncate FP32 numbers to BF16 numbers.

The post-processing component 312 can include rectified linear unit (ReLU) circuitry configured to perform a rectified linear activation function on the accumulated data. The ReLU can output the accumulated value directly if the accumulated value is positive. If the accumulated value if negative, the ReLU can output a value of zero. The post-processing component 312 can include a ReLU in combination with rounding or truncating circuitry. In this way, the post-processing component 312 can reduce the precision of positive values, while outputting a value of zero for negative values.

The post-processing component 312 can include circuitry for performing other operations on the accumulated data. For example, the post-processing component 312 can include circuitry for performing other activation functions, e.g., binary step functions, linear activation functions, and/or non-linear activation functions, such as sigmoid functions.

In some implementations, the post-processing component 312 is a programmable component that can perform multiple post-processing operations. In this way, a host interface (or another component of the core 103) can adjust the post-processing operation for different input matrices, different machine learning computations, or for other purposes. For example, some machine learning computations may require or perform better when higher precision values are output by the cells. In this example, the post-processing component 312 can be controlled to either round accumulated values, e.g., to one of multiple possible lower precision forms, or to pass the higher precision accumulated values directly. Control signals can be used to change the post-processing operation performed by a programmable post-processing component 312. Continuing the previous example, the post-processing component 312 can round accumulated values to a first lower precision format in response to receiving a first control signal, can round accumulated values to a second lower precision format in response to receiving a second control signal, or to not round at all in response to receiving a third control signal. In another example, the post-processing component 312 can perform a given activation function of a set of possible activation functions of the post-processing component 312 based on the control signal.

After the post-processing is complete, the post-processing component 312 can send the post-processed data to an output register 314. The output register 314 can shift the post-processed data to an adjacent cell, e.g., to a bottom adjacent cell, or to an accumulator depending on the position of the cell within the systolic array, using an output bus 336.

In some implementations, the post-processing component 312 can be part of the accumulator 310. As the accumulator 310 can include its own registers, the output register 314 can be omitted in this example.

If the post-processing operation is idempotent, e.g., a ReLU operation, the post-processing can be performed at every step. In this example, the post-processing component can be placed between accumulators and the accumulators can be used to shift the post-processed data from the cell.

The cell also includes buses for shifting matrix elements in from other cells and out to other cells. For example, the cell includes the bus 324 for receiving matrix elements from a left adjacent cell and a bus 332 for shifting matrix elements to a right adjacent cell. Similarly, the cell includes the bus 322 for receiving matrix elements from a top adjacent cell and a bus 328 for shifting matrix elements to a bottom adjacent cell 328. The cell also includes a bus 330 for receiving accumulated values, e.g., post-processed values, from a top adjacent cell and a bus 334 for shifting accumulated values received from the top adjacent cell to a bottom adjacent cell. Each bus can be implemented as a set of wires.

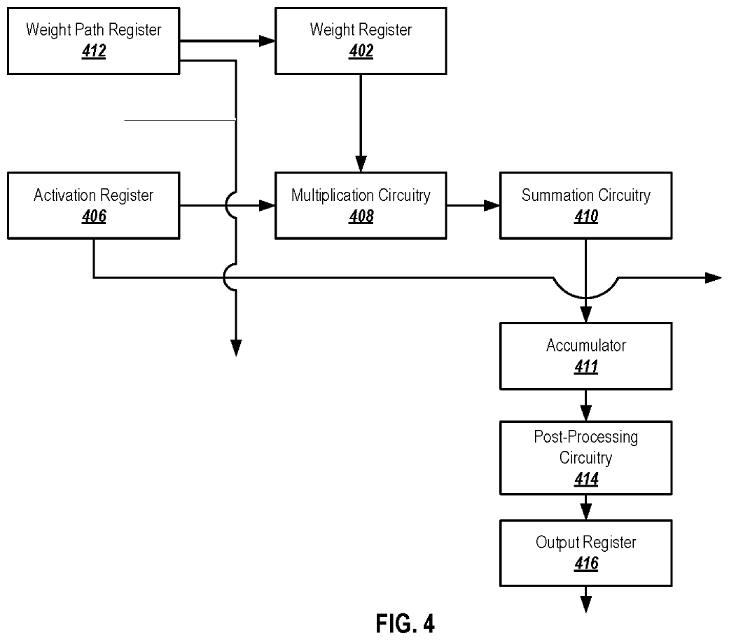

FIG. 4 shows an example architecture 400 of a cell inside a systolic array, e.g., the systolic array 206 of FIG. 2. In this example, the cells of the systolic array are used to perform neural network computations. This provides an example of how post-processing circuitry 414 can be used in systolic array cells of neural network processing units.

The cell can include an activation register 406 that stores an activation input. The activation register can receive the activation input from a left adjacent cell, i.e., an adjacent cell located to the left of the given cell, or from a value loader or buffer, depending on the position of the cell within the systolic array. The cell can include a weight register 402 that stores a weight input. The weight input can be transferred from a top adjacent cell or from a weight fetcher interface, depending on the position of the cell within the systolic array. Multiplication circuitry 408 can be used to multiply the weight input from the weight register 402 with the activation input from the activation register 406. The multiplication circuitry 408 can output the product to summation circuitry 410.

The summation circuitry can sum the product and the accumulated value from the sum in register 404 to generate a new accumulated value. The summation circuitry 410 can then send the new accumulated value to an accumulator 411. Once all of the matrix elements of input matrices have been processed, the accumulator 411 can send the final accumulated value to post-processing circuitry 414. The post-processing circuitry 414 can perform one or more post-processing operations on the accumulated value prior to outputting the accumulated value to an accumulator unit. As described above, the post-processing can include, for example, rounding, truncating, and/or applying a ReLU to the accumulated value.

The cell can also shift the weight input and the activation input to adjacent cells for processing. For example, the weight register 402 can send the weight input to another weight register in the bottom adjacent cell. The activation register 406 can send the activation input to another activation register in the right adjacent cell. Both the weight input and the activation input can therefore be reused by other cells in the array at a subsequent clock cycle.

In some implementations, the cell also includes a control register. The control register can store a control signal that determines whether the cell should shift either the weight input or the activation input to adjacent cells. In some implementations, shifting the weight input or the activation input takes one or more clock cycles. The control signal can also determine whether the activation input or weight inputs are transferred to the multiplication circuitry 408, or can determine whether the multiplication circuitry 408 operates on the activation and weight inputs. The control signal can also be passed to one or more adjacent cells, e.g., using a wire.

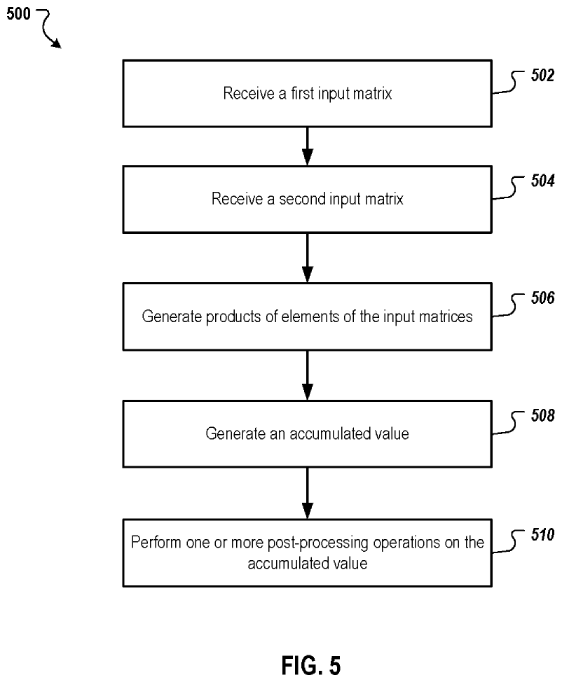

FIG. 5 is a flow diagram of an example process 500 for performing matrix multiplication and performing one or more post-processing operations. The process 500 can be performed by each of one or more cells of a systolic array of a multiplication unit.

A first input register of a cell receives a first input matrix (502). For example, the first input matrix can represent an activation input.

A second input register of the cell receives a second input matrix (504). For example, the second input matrix can represent a weight input.

Multiplication circuitry of the cell determines the products of elements of the input matrices (506). For example, the multiplication circuitry can perform matrix-matrix multiplication by multiplying, one or more at a time, corresponding elements of the first input matrix by corresponding elements of the second input matrix.

An accumulator of the cell accumulates the sum of the products (508). For example, a summation element of the cell can determine a sum of the most recent product and the current accumulated value stored in the accumulator and store the updated accumulator value in the accumulator.

A post-processing component of the cell performs one or more post-processing operations on the accumulated value (510). After all of the products are determined for the input matrices, the accumulator can output the final accumulated value to the post-processing component. The post-processing component can then perform a rounding, a truncation, an ReLU operation, or another appropriate operation on the accumulated value. The post-processing component can then output the post-processed value from the cell, e.g., by way of an output register.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array), an ASIC (application specific integrated circuit), or a GPGPU (General purpose graphics processing unit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A matrix multiplication unit, comprising:
a plurality of cells arranged in a systolic array, wherein each cell comprises:
multiplication circuitry configured to determine a product of elements of input matrices;
an accumulator configured to determine an accumulated value by accumulating a sum of the products output by the multiplication circuitry; and
a post-processing component configured to determine a post-processed value by performing one or more post-processing operations on the accumulated value.

2. The matrix multiplication unit of claim 1, wherein each cell further comprises an output register configured to receive the post-processed value and shift the post-processed value out of the cell.

3. The matrix multiplication unit of claim 1, wherein the post-processing component comprises rounding circuitry configured to round the accumulated value from a higher precision number format to a lower precision number format.

4. The matrix multiplication unit of claim 3, wherein each cell contains a number of output wires equal to a number of bits of the lower precision number format.

5. The matrix multiplication unit of claim 1, wherein the post-processing component comprises truncating circuitry configured to truncate the accumulated value from a higher precision number format to a lower precision number format.

6. The matrix multiplication unit of claim 1, wherein the post-processing component comprises rectified linear unit (ReLU) circuitry configured to:
output the accumulated value when the accumulated value is positive; and
output a value of zero when the accumulated value is negative or zero.

7. The matrix multiplication unit of claim 1, wherein the post-processing component is programmable and is configured to perform one of multiple post-processing operations based on a control signal.

8. A data processing cell, comprising:
multiplication circuitry configured to determine a product of elements of input matrices;
an accumulator configured to determine an accumulated value by accumulating a sum of the products output by the multiplication circuitry; and
a post-processing component configured to determine a post-processed value by performing one or more post-processing operations on the accumulated value.

9. The data processing cell of claim 8, further comprising an output register configured to receive the post-processed value and shift the post-processed value out of the data processing cell.

10. The data processing cell of claim 8, wherein the post-processing component comprises rounding circuitry configured to round the accumulated value from a higher precision number format to a lower precision number format.

11. The data processing cell of claim 10, further contains a number of output wires equal to a number of bits of the lower precision number format.

12. The data processing cell of claim 8, wherein the post-processing component comprises truncating circuitry configured to truncate the accumulated value from a higher precision number format to a lower precision number format.

13. The data processing cell of claim 8, wherein the post-processing component comprises rectified linear unit (ReLU) circuitry configured to:
output the accumulated value when the accumulated value is positive; and
output a value of zero when the accumulated value is negative or zero.

14. The data processing cell of claim 8, wherein the post-processing component is programmable and is configured to perform one of multiple post-processing operations based on a control signal.

15. A method for multiplying matrices, the method comprising:
receiving, by a first input register of a cell, a first input matrix;
receiving, by a second input register of the cell, a second input matrix;
generating, by multiplication circuitry of the cell, products of elements of the first input matrix with elements of the second input matrix;
generating, by an accumulator of the cell, an accumulated value accumulating the products; and
performing, by a post-processing component of the cell, one or more post-processing operations on the accumulated value.

16. The method of claim 15, wherein performing the one or more post-processing operations comprises rounding the accumulated value from a higher precision number format to a lower precision number format.

17. The method of claim 15, wherein performing the one or more post-processing operations comprises truncating the accumulated value from a higher precision number format to a lower precision number format.

18. The method of claim 15, wherein performing the one or more post-processing operations comprises:
outputting the accumulated value when the accumulated value is positive; and
outputting a value of zero when the accumulated value is negative or zero.

19. The method of claim 15, wherein performing the one or more post-processing operations comprises:
receiving a control signal; and
performing a given post-processing operation of multiple post-processing operations based on the control signal.

20. The method of claim 15, further comprising:
receiving, by an output register, the post-processed accumulated value from the post-processing component; and
shifting, by the post-processing component, the post-processed accumulated value out of the cell.
